(19) United States
(12) Patent Application Publication
(10) Pub. No.: US 2012/0021379 A1
(43) Pub. Date: Jan. 26, 2012

(54) PERIODONTAL SCALER

(76) Inventor: Tamara L. Beach, Chattanooga, TN (US)

(21) Appl. No.: 12/841,079

(22) Filed: Jul. 21, 2010

(51) Int. Cl. A61C 17/00

(52) U.S. Cl. 433/143

(57) ABSTRACT

A periodontal scaler is provided, comprising an arcuate shank and an arcuate blade. The arcuate blade being designed to conform to the roughly cylindrical surfaces found on the roots of teeth. This conforming feature of the instrument's blade increases its cleaning efficiency by maximizing contact between the blade's surface and the root, and guiding the instrument along the root by holding its convex edges within the concave shape of the blade.

### CROSS REFERENCE TO RELATED APPLICATIONS

This application claims benefit to non-provisional application Ser. No. 12/357,375, which is incorporated by reference herein in its entirety.

### FIELD OF THE INVENTION

The present device is a periodontal scaler designed to facilitate the cleaning of the root surfaces of teeth, particularly those of patients with periodontal disease. This periodontal scaler is designed to be more accurately adapted to the tooth facilitating faster and more effective removal of plaque and calculus from the roots minimizing trauma caused to nearby tissues and fatigue by the user.

### BACKGROUND

Periodontal disease is an inflammation of the gingival tissues of teeth, which can result in pockets and bone loss and even the eventual loss of teeth. This condition is often associated with severely receded gums, which leave the roots of teeth exposed. In order to treat this disease, the surfaces of the roots must be thoroughly cleaned of plaque and calculus. This cleaning typically involves the use of specialized scraping tools, called periodontal scalers, which are designed to be used below the gum line, where the roots exist.

Periodontal scalers are currently available on the market, however, the working ends of these tools do not have the proper angles required to easily access the affected root surfaces, particularly the curved surfaces of the roots of each molar. Furthermore, current devices do not have blades which conform to the cylindrical shape of the root so as to maximize contact between the blade and the root.

What is needed is an instrument capable of properly cleaning the roots of teeth, particularly the surfaces that are not easily accessible, including the furcation of the roots of each molar, having one or more working ends with the proper angles required to reach the surfaces of each root and a blade capable of conforming to the cylindrical shape of the root so as to maximize contact between the blade and the root.

### SUMMARY OF THE INVENTION

It is an aspect of the present device to provide a periodontal scaler capable of conforming closely to the root of a molar with an arcuate shaped cutting surface capable of removing plaque and calculus from each root.

The above aspect can be obtained by a periodontal scaler, comprising an elongated handle with a first end and a second end, a first working end connected to the first end of the elongated handle, the working end further comprising an offset shaft having a first end and a second end, wherein the first end of the offset shaft is connected to the first end of the elongated handle, an arcuate shank having a first end and a second end, and an upper section and a lower section divided by an angle, wherein the first end of the arcuate shank is connected to the second end of the offset shaft, and an arcuate blade having a first end and a second end, wherein the first end of the arcuate blade is connected to the second end of the arcuate shank at an angle roughly perpendicular the lower section of the arcuate shank.

These, together with other aspects and advantages, which will subsequently become apparent, and reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective view of a double-ended periodontal scaler, according to an embodiment;

FIG. 2A is an enlarged perspective view of the working end of the periodontal scaler, in a vertical position, displaying an offset shaft, an arcuate shank and an arcuate blade with the point of the cutting blade facing forward, according to an embodiment;

FIG. 2B is an enlarged perspective view of the working end of the periodontal scaler as displayed in FIG. 2A, which has been rotated counter-clockwise ninety (90) degrees, according to an embodiment;

FIG. 2C is an enlarged perspective view of the working end of the periodontal scaler as displayed in FIG. 2A, which has been rotated counter-clockwise one hundred eighty (180) degrees, according to an embodiment;

FIG. 2D is an enlarged perspective view of the working end of the periodontal scaler as displayed in FIG. 2A, which has been rotated counter-clockwise two hundred seventy (270) degrees, according to an embodiment;

FIG. 3 is an illustrational view of the periodontal scaler being utilized to clean the root surface of a tooth, according to an embodiment;

FIG. 4 is an illustrational view of the periodontal scaler being utilized to clean a root, comprising an enlarged, top, cutaway view of the periodontal scaler's arcuate blade and an enlarged, top, cutaway view of a root, according to an embodiment; and

FIG. 5 is an illustrational view of the periodontal scaler being utilized to clean a root, comprising an enlarged, side view of the end of the periodontal scaler, including its arcuate blade, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

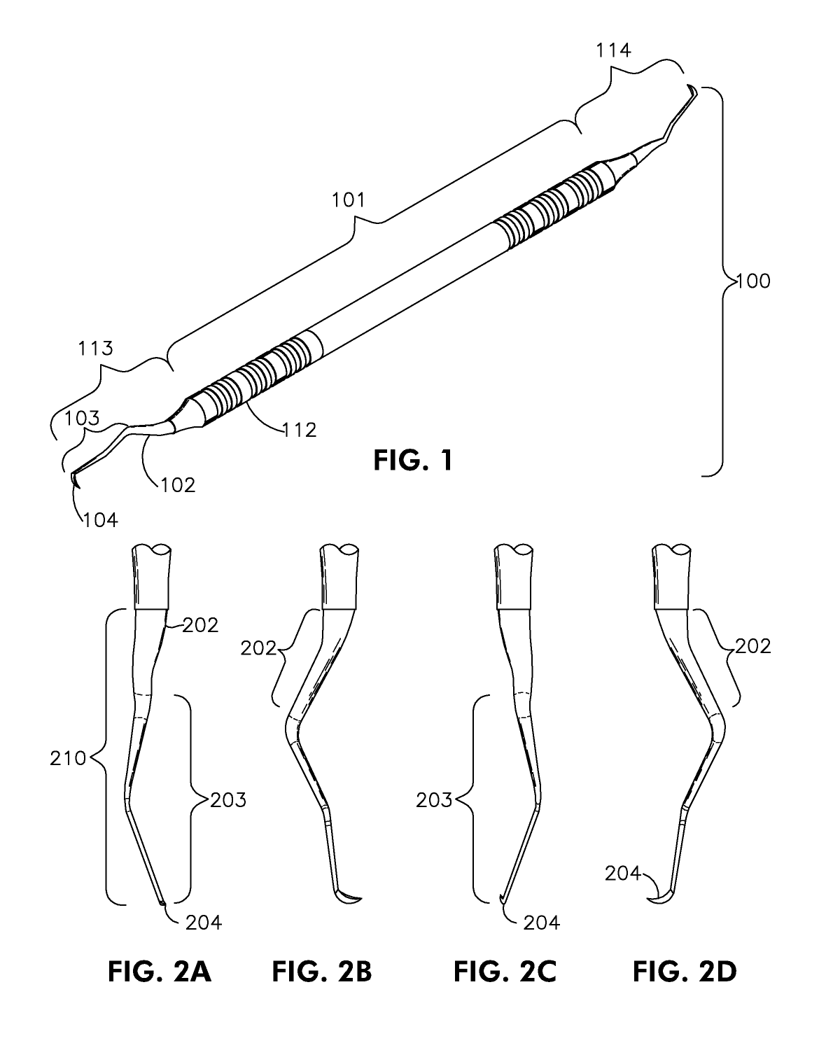

FIG. 1 is a perspective view of a double-ended periodontal scaler 100, according to an embodiment.

The double-ended periodontal scaler 100, as depicted in FIG. 1, can be comprised of an elongated handle 101. The cross-sectional shape of this handle 101 can be cylindrical, triangular, octagonal or any other shape suitable to sufficiently control the periodontal scaler 100. The scaler 100 is depicted in FIG. 1 as having a cylindrical cross-sectional shape with grooves 112 carved into its surface to facilitate gripping.

The double-ended periodontal scaler 100, as depicted in FIG. 1, can be composed of stainless steel, titanium, plastic, or any other suitable material known to those of average skill in the relevant art, or any combination of such materials.

The double-ended periodontal scaler 100 can comprise a working end at only one end of the handle 101, however, the preferred embodiment, as shown in FIG. 1, comprises a first working end 113 on one end of the handle 101 and a second working end 114 on the other end, which is the minor image of the first working end 113. This configuration allows the user to clean both sides of a particular root (not pictured).

Each working end 113 and 114 comprises an offset shaft 102, which can be connected to one end of the handle 101. The shaft 102 can taper from its thickest width at the point where it connects to the handle 101 to its thinnest width where it meets the arcuate shank 103, which itself, is connected to an arcuate blade 104 at its other end. The offset shaft 102 bends outward from the end of the handle 101.

These working ends 113 and 114 can be comprised of several parts connected together or formed from a single piece of material such as stainless steel or some other suitable material.

FIG. 2A is an enlarged perspective view of the working end 210 of the periodontal scaler in a vertical position displaying an offset shaft 202, an arcuate shank 203 and an arcuate blade 204 with the point of the cutting blade facing forward, according to an embodiment.

From this viewpoint, the angle of the arcuate shank 203 is readily apparent. In this embodiment the angle of the arcuate shank 203 is approximately one hundred twenty (120) degrees. The purpose of this angle is to position the arcuate blade 204 inward toward the roots allowing the user to clean the root's surface while holding the instrument in a relatively vertical position. This figure displays the tip of the arcuate blade 204 pointing out toward the front of the page.

FIG. 2B is an enlarged perspective view of the working end 210 of the periodontal scaler as displayed in FIG. 2A, which has been rotated counter-clockwise ninety (90) degrees, according to an embodiment.

This viewpoint displays the offset shaft 202, according to an embodiment, which functions to allow the tool to move freely around the tooth being cleaned and avoiding the nearby cheek, tongue and viewing mirror (not pictured). This offset shaft 202 can have an angle approximately thirty (30) degrees with relation to the longitudinal axis of the elongated handle (not pictured).

FIG. 2C is an enlarged perspective view of the working end 210 of the periodontal scaler as displayed in FIG. 2A, which has been rotated counter-clockwise one hundred eighty (180) degrees, according to an embodiment.

As in FIG. 2A, this viewpoint clearly displays the angle of the arcuate shank 203, according to an embodiment, which functions to hold the gum (not pictured) away from the tooth being cleaned, allowing the user to view the arcuate blade 204 and the root surface being cleaned.

FIG. 2D is an enlarged perspective view of the working end 210 of the periodontal scaler as displayed in FIG. 2A, which has been rotated counter-clockwise two hundred seventy (270) degrees, according to an embodiment.

As in FIG. 2B, this viewpoint clearly displays the offset shaft 202, but from the opposite angle. This viewpoint also displays the sharpened side of the arcuate blade 204.

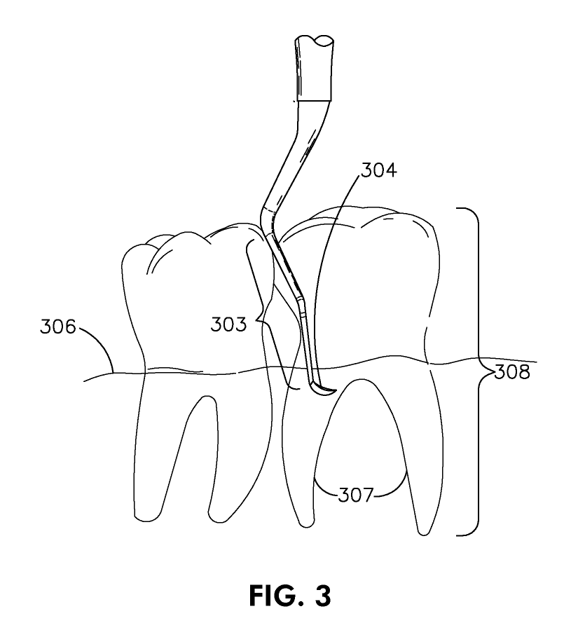

FIG. 3 is an illustrational view of the periodontal scaler being utilized to clean the root surface of a tooth, according to an embodiment.

This view clearly displays how the arcuate shank 303 allows the instrument, and particularly the arcuate blade 304, to be utilized below the gum line 306 where it can access the roots 307 of the tooth being cleaned 308.

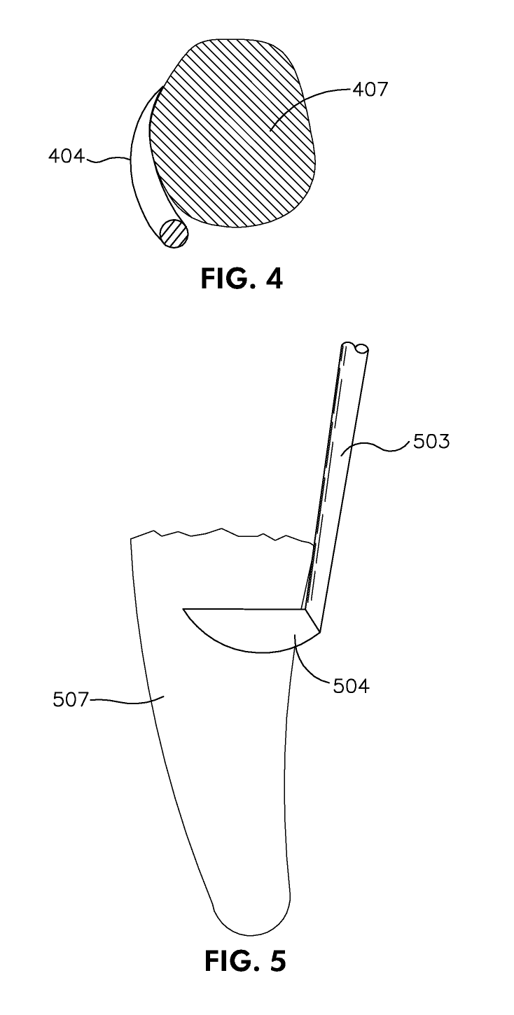

FIG. 4 is an illustrational view of the periodontal scaler being utilized to clean a root 407, comprising an enlarged, top, cutaway view of the periodontal scaler's arcuate blade 404 and an enlarged, top, cutaway view of a root 407, according to an embodiment.

This view shows the purpose of the arcuate blade's 404 particular shape, which can be made to conform to the roughly cylindrical shape of a typical root 407. By conforming to the root 407 and being placed at the base of the root 407 and stroking upwards. The surface of the root 407 can be more efficiently cleaned of plaque and calculus with an arcuate blade 404 than it could with a straight blade (not pictured), which does not conform to the shape of the root, and thus can contact the root at only one point at any time.

Furthermore, this arcuate shape, particularly its concave shape, can be used to guide the arcuate blade 404 onto the root 407 and to keep it there by inhibiting lateral movement as it is moved up and against the root 407 being cleaned. This feature can help to reduce trauma to nearby tissues (not pictured), by reducing the chance that control of the blade 404 will be lost, and by reducing the amount of time required to clean each root 407 by maintaining constant contact with the root.

FIG. 5 is an illustrational view of the periodontal scaler being utilized to clean a root 507, comprising an enlarged, side view of the end of the periodontal scaler, including its arcuate blade 504, according to an embodiment.

This view shows the position of the arcuate blade 504 as it interacts with the root 507. This view clearly displays the angle of the arcuate blade 504 with respect to the arcuate shank 503 and the root 507 being cleaned by the instrument.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A periodontal scaler, comprising:
an elongated handle with a first end and a second end;
a first working end connected to the first end of the elongated handle;
the first working end further comprising an offset shaft having a first end and a second end, wherein the first end of the offset shaft is connected to the first end of the elongated handle;
an arcuate shank having a first end and a second end, and an upper section and a lower section are connected at an angle, wherein the first end of the arcuate shank is connected to the second end of the offset shaft; and
an arcuate blade having a first end and a second end, wherein the first end of the arcuate blade is connected to the second end of the arcuate shank at an angle roughly perpendicular the lower section of the arcuate shank

2. The periodontal scaler as recited in claim 1, wherein the second end of the elongated handle is connected to a second working end which is identical to the first working end except the second working end is the minor image of the first working end with a reversed offset and reversed curves.

3. The periodontal scaler as recited in claim 1, wherein the arcuate blade is configured to conform to a cylindrically-shaped root when the lower section of the arcuate shank is held in a position roughly parallel to the root being cleaned, this ability to conform providing a self-guiding aspect to the periodontal scaler.

4. The periodontal scaler as recited in claim 1, wherein the elongated handle comprises a circular cross-sectional shape.

5. The periodontal scaler as recited in claim 1, wherein the elongated handle comprises an octagonal cross-sectional shape.

6. The periodontal scaler as recited in claim 1, wherein the elongated handle comprises a triangular cross-sectional shape.

7. The periodontal scaler as recited in claim 1, wherein the offset shaft has an offset angle, which can form an angle with the central longitudinal axis of the elongated handle that is approximately thirty (30) degrees.

8. The periodontal scaler as recited in claim 1, wherein the arcuate shank forms an angle that is approximately one-hundred twenty (120) degrees.

9. The periodontal scaler as recited in claim 1, wherein the arcuate blade is approximately perpendicular to the central longitudinal axis of the elongated handle.

10. The periodontal scaler as recited in claim 1, wherein the arcuate blade is concave so as to conform to a roughly cylindrical shape when the periodontal scaler is held in a position nearly parallel to the length of a roughly cylindrical shape, this ability to conform to the rounded side of a roughly cylindrical shape providing a self-guiding aspect to the periodontal scaler.

11. The periodontal scaler as recited in claim 1, wherein the scaler is comprised of stainless steel.

12. The periodontal scaler as recited in claim 1, wherein the scaler is comprised of titanium.

13. The periodontal scaler as recited in claim 1, wherein the scaler is comprised of plastic.
